(19) United States
(12) Patent Application Publication
(10) Pub. No.: US 2022/0153344 A1
(43) Pub. Date: May 19, 2022

(54) STEERING CONTROL NEUTRAL CALIBRATION FOR TERRAIN WORKING VEHICLE

(71) Applicant: Excel Industries, Inc., Hesston, KS (US)

(72) Inventor: Royce A. Steinert, Hutchinson, KS (US)

(21) Appl. No.: 17/520,285

(22) Filed: Nov. 5, 2021

Related U.S. Application Data
(60) Provisional application No. 63/114,153, filed on Nov. 16, 2020.

(51) Int. Cl. B62D 11/00; G05G 5/03

(52) U.S. Cl. CPC B62D 11/003; B62D 11/04; G05G 5/03

(57) ABSTRACT

A drive-by-wire steering control system for a terrain working vehicle configured to determine a signal band corresponding to a mechanical neutral position of a steering control before the steering control moves to a forward or rearward drive position. The drive-by-wire steering control system may include a steering control movable between a first position and a second position, a sensor configured to detect a current position of the steering control and send a signal to a control corresponding to the current position of the steering control. The controller may be configured to receive the signal from the sensor and direct a propulsion system to drive the terrain working vehicle forward, backward, or sit idle.

### CROSS-REFERENCE TO RELATED APPLICATIONS

This application claims the benefit of U.S. Provisional Application No. 63/114,153 entitled “Steering control neutral calibration for terrain working vehicle,” and filed Nov. 16, 2020. The entirety of the aforementioned application is incorporated by reference herein.

### FIELD

Aspects provided relate to control of terrain working vehicles. More particularly, aspects herein relate to steering control neutral calibration for drive-by-wire terrain working vehicles.

### BACKGROUND

At a basic level, a terrain working vehicle may include a propulsion system to drive the vehicle and one or more steering levers to control the propulsion system. Each steering lever may move forwards and backwards within a slot to cause the propulsion system to drive the vehicle forwards or backwards, respectively. An intermediate portion of the slot was typically designated as a neutral position at which the propulsion system drives neither forwards nor backwards but rather idles in place.

In the past, the steering levers were mechanically connected to the propulsion system. In mechanically connected steering control systems, the neutral position was the intermediate portion of the slot that corresponded to the neutral setting of the propulsion system (i.e., a mechanical neutral position). Often, the slot had a “T” shape such that a second slot extended laterally outward from an intermediate portion of the slot to permit the steering lever to move laterally when in the neutral position.

Later, steering levers were electrically connected to a controller which itself was operatively coupled to the propulsion system (e.g., drive-by-wire). A sensor would detect the position of the steering lever within the slot and send a signal to the controller that indicated whether the propulsion system should drive the vehicle forwards or backwards or neither and let it sit idle. These so-called drive-by-wire steering levers would have the neutral position mechanically set so that an output signal corresponding to a neutral condition of the propulsion system received by the controller was sent by the sensor when the steering lever was aligned with the second slot. These prior systems required adjusting an angular rotation of the steering sensor until a measured output signal from the sensor corresponding to the neutral condition of the propulsion system was provided to the controller when the steering lever was in the mechanical neutral position. In other words, the steering lever was able move laterally into the second slot when the propulsion system was in the neutral condition. This calibration was manually performed during manufacture of the terrain working vehicle or during maintenance.

Misalignment between this mechanically set neutral position of the steering lever and the second slot, however, could result in the steering lever being moved laterally into the second slot where the operator believes the vehicle should be in neutral only to have the controller actually still direct the propulsion system to drive forwards or backwards.

### SUMMARY

At a high level, a drive-by-wire steering control system for a terrain working vehicle may determine a signal band of a connected sensor corresponding to a mechanical neutral position of a steering control prior to the steering control moving to a forward or rearward drive position. The drive-by-wire steering control system may include a steering control movable between a first position and a second position, a sensor configured to detect a current position of the steering control and send a signal to a controller corresponding to the current position of the steering control. The controller may be configured to receive the signal from the sensor and direct a propulsion system to drive the terrain working vehicle forward, backward, or sit idle.

In one aspect of the drive-by-wire steering control system, the steering control comprises a steering lever that is pivotal in a “T” shaped slot. That is, the steering lever may pivot in a longitudinal direction of the terrain working vehicle between the first position and the second position when the steering lever is aligned with a longitudinal portion of the “T” shaped slot. In addition, the steering lever of this aspect may pivot in a lateral direction of the terrain working vehicle when the steering lever is aligned with a lateral portion of the “T” shaped slot. The lateral portion of the “T” shaped slot may serve as a physical obstruction to the steering lever to prevent or limit pivotal movement in the longitudinal direction. During operation of the terrain working vehicle, the propulsion system begins in a neutral condition and the steering lever is in the lateral portion of the “T” shaped slot. When the operator is ready to begin driving the terrain working vehicle the steering lever is moved into alignment with the longitudinal portion of the “T” shaped slot. This movement of the steering lever triggers the sensor to measure a longitudinal position of the steering lever as it is moved into said alignment and sends a signal corresponding to such position to the controller. For example, this measurement may be triggered by a change in condition of a switch that is associated with the steering lever being in the lateral portion of the “T” shaped slot. Based on this measurement, the controller then determines a signal band corresponding to the mechanical neutral position of the steering lever. Thus, the signal band corresponding to the mechanical neutral position of the steering lever is able to be determined by the controller each time (or at any interval) the steering lever is pivoted from the lateral portion into alignment with the longitudinal portion of the “T” shaped slot. In some aspects, the steering lever may close a neutral switch when in the lateral portion. When the neutral switch opens, the controller, which was monitoring the neutral switch, knows the steering lever is pivoting towards the longitudinal portion and thus determines the signal band corresponding to the mechanical neutral position. Because the signal band can be reset during each use of the steering lever, wear and tear on the terrain working vehicle over extended periods of time will not cause misalignment between the signal band and the mechanical neutral position.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE SEVERAL VIEWS OF THE DRAWINGS

Illustrative embodiments of the present invention are described in detail below with reference to the attached drawing figures, which are incorporated by reference herein and wherein:

FIG. 1 depicts a perspective view of a terrain working vehicle having a drive-by-wire steering control system comprising steering levers positioned in alignment with a longitudinal portion of a “T” shaped slot, in accordance with aspects hereof;

FIG. 2 depicts a perspective view of the terrain working vehicle of FIG. 1 with the steering levers positioned in alignment with a lateral portion of a “T” shaped slot and in a mechanical neutral position, in accordance with aspects hereof;

FIG. 3 depicts a perspective view of the terrain working vehicle of FIG. 1 with the steering levers in a first position corresponding to forward propulsion of the terrain working vehicle, in accordance with aspects hereof;

FIG. 4 depicts a perspective view of the terrain working vehicle of FIG. 1 with the steering levers in a second position corresponding to rearward propulsion of the terrain working vehicle, in accordance with aspects hereof;

FIG. 5 depicts a detail perspective view of the terrain working vehicle of FIG. 1 with a portions removed to reveal a sensor for detecting a position of the steering lever, in accordance with aspects hereof;

FIG. 6 is a system flow diagram illustrating a drive-by-wire steering control system for controlling propulsion of the terrain working vehicle of FIG. 1, in accordance with aspects hereof;

FIG. 7A is a plot of a speed ratio for both high and low speed ranges of the left drive wheel(s) of the terrain working vehicle of FIG. 1 versus an output signal from a sensor, in accordance with aspects hereof;

FIG. 7B is a plot of a speed ratio for both high and low speed ranges of the right drive wheel(s) of the terrain working vehicle of FIG. 1 versus an output signal from the sensor, in accordance with aspects hereof;

FIG. 7C is another plot of a speed ratio for both high and low speed ranges of the left drive wheel(s) of the terrain working vehicle of FIG. 1 versus an output signal from the sensor as calibrated from a different measured reference point, in accordance with aspects hereof;

FIG. 7D depicts a portion of the plot of FIG. 7A and a portion of the plot of FIG. 7C, in accordance with aspects hereof;

FIG. 7E is an alternative plot of a non-linear speed ratio for either left or right drive wheels of the terrain working vehicle of FIG. 1 versus an output signal from the sensor; and

FIG. 8 depicts a flow diagram of a method of calibrating the drive-by-wire steering control system of FIG. 6, in accordance with aspects hereof.

### DETAILED DESCRIPTION

The subject matter of embodiments of the present invention is described with specificity herein to meet statutory requirements. However, the description itself is not intended to limit the scope of this patent. Rather, the inventors have contemplated that the claimed subject matter might also be embodied in other ways, to include different features or combinations of features similar to the ones described in this document, in conjunction with other present or future technologies. Further, it should be appreciated that the figures do not necessarily represent an all-inclusive representation of the embodiments herein and may have various components hidden to aid in the written description thereof.

At a high level, a drive-by-wire steering control system for a terrain working vehicle may determine a signal band of a connected sensor corresponding to a mechanical neutral position of a steering control prior to the steering control moving to a forward or rearward drive position. The drive-by-wire steering control system may include a steering control movable between a first position and a second position, a sensor configured to detect a current position of the steering control and send a signal to a controller corresponding to the current position of the steering control. The controller may be configured to receive the signal from the sensor and direct a propulsion system to drive the terrain working vehicle forward, backward, or sit idle.

In one aspect of the drive-by-wire steering control system, the steering control comprises a steering lever that is pivotal in a “T” shaped slot. That is, the steering lever may pivot in a longitudinal direction of the terrain working vehicle between the first position and the second position when the steering lever is aligned with a longitudinal portion of the “T” shaped slot. In addition, the steering lever of this aspect may pivot in a lateral direction of the terrain working vehicle when the steering lever is aligned with a lateral portion of the “T” shaped slot. The lateral portion of the “T” shaped slot may serve as a physical obstruction to the steering lever to prevent or limit pivotal movement in the longitudinal direction. During operation of the terrain working vehicle, the propulsion system begins in a neutral condition and the steering lever is in the lateral portion of the “T” shaped slot. When the operator is ready to begin driving the terrain working vehicle the steering lever is moved into alignment with the longitudinal portion of the “T” shaped slot. This movement of the steering lever triggers the sensor to measure a longitudinal position of the steering lever as it is moved into said alignment and sends a signal corresponding to such position to the controller. For example, this measurement may be triggered by a change in condition of a switch that is associated with the steering lever being in the lateral portion of the “T” shaped slot. Based on this measurement, the controller then determines a signal band corresponding to the mechanical neutral position of the steering lever. Thus, the signal band corresponding to the mechanical neutral position of the steering lever is able to be determined by the controller each time (or at any interval) the steering lever is pivoted from the lateral portion into alignment with the longitudinal portion of the “T” shaped slot. In some aspects, the steering lever may close a neutral switch when in the lateral portion. When the neutral switch opens, the controller, which was monitoring the neutral switch, knows the steering lever is pivoting towards the longitudinal portion and thus determines the signal band corresponding to the mechanical neutral position. Because the signal band can be reset during each use of the steering lever, wear and tear on the terrain working vehicle over extended periods of time will not cause misalignment between the signal band and the mechanical neutral position.

Further, manufacturing costs, repair and warranty cost savings are realized with the present invention because the calibration of the neutral band described herein does not need to be set during assembly of the terrain working vehicle, unlike prior art vehicles. Manufacturing cost savings are realized through simplified assembly of the terrain working vehicle (e.g., by decreasing assembly time and by decreasing requisite skill needed to complete assembly, among others). Further, warranty savings are realized because an assembly error may be corrected automatically by the calibration of the neutral band, as described herein, during operation of the terrain working vehicle, obviating the need for repair and/or service for such assembly error. In addition, less training is required for repair/servicing employees and less repair/service time is needed because the misalignment problem of the prior art need not be diagnosed. Moreover, the simplified assembly of the present invention (i.e., removing the prior art requirement of setting the neutral band during assembly) results in higher confidence in the assembled terrain working vehicle.

Aspects hereof may be described using directional terminology. For example, the Cartesian coordinate system may be used to describe positions and movement or rotation of the features described herein. Accordingly, some aspects may be described with reference to three mutually perpendicular axes. The axes may be referred to herein as lateral, longitudinal, and vertical, and may be indicated by reference characters X, Y, and Z, respectively, in the accompanying figures. For example, the terms “vertical” and “vertically” as used herein refer to a direction perpendicular to each of the lateral and longitudinal axes. Additionally, relative location terminology will be utilized herein. For example, the term “proximate” is intended to mean on, about, near, by, next to, at, and the like. Therefore, when a feature is proximate another feature, it is close in proximity but not necessarily exactly at the described location, in some aspects. Additionally, the term “distal” refers to a portion of a feature herein that is positioned away from a midpoint of the feature.

As used herein, the term “steering control” and/or “steering lever” generally refers to a control device that moves between a plurality of positions to control any one of the systems described above or any other system controllable by such pivoting as will be recognized by one having skill in the art. For example, in some aspects, “steering control” may comprise actuatable wheels, buttons, knobs, handles, joysticks, or other such mechanical structures configured to pivot, rotate, slide, retract/extend, or any combination of mechanical motions for directing any one of the systems (e.g., a propulsion system of the terrain working vehicle) described herein. Further, such term is not limited to a control device that controls a propulsion system, a steering system, or both a propulsion system and a steering system of the terrain working vehicle.

For the sake of brevity, the figures and description that follow describe the terrain working vehicle in reference to a particular embodiment of a zero-turn riding mower. However, the illustrated embodiment is merely one aspect of the present invention, which may be employed on numerous other types of vehicles or mowers having drive-by-wire steering control systems (e.g., a stand-on vehicle, a non-zero turn riding vehicle, etc.).

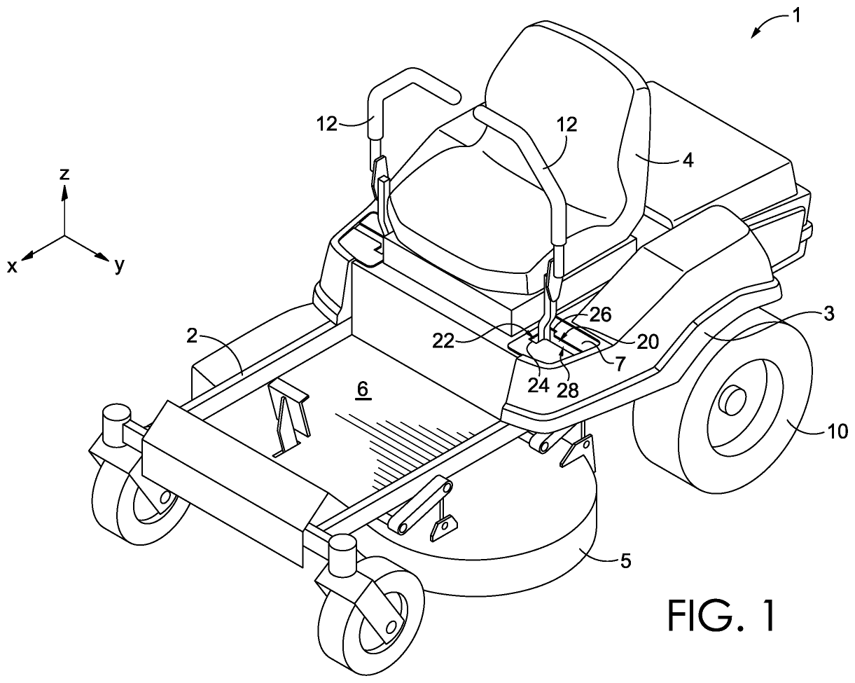

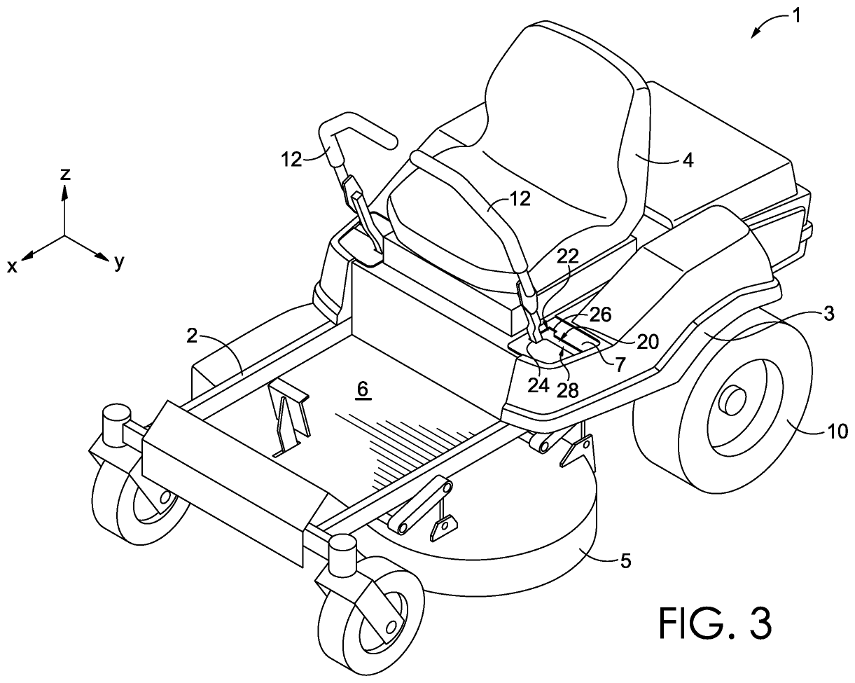

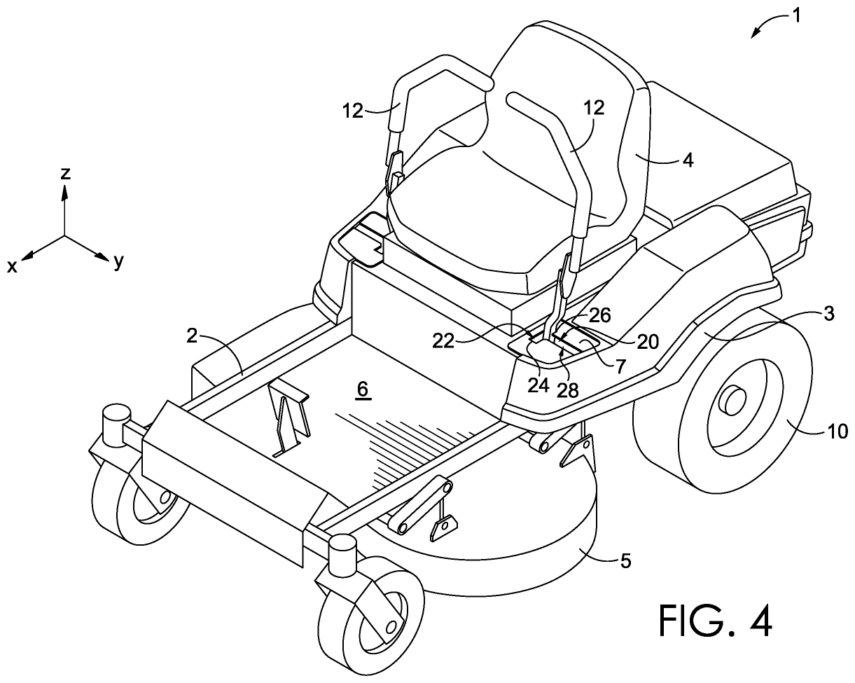

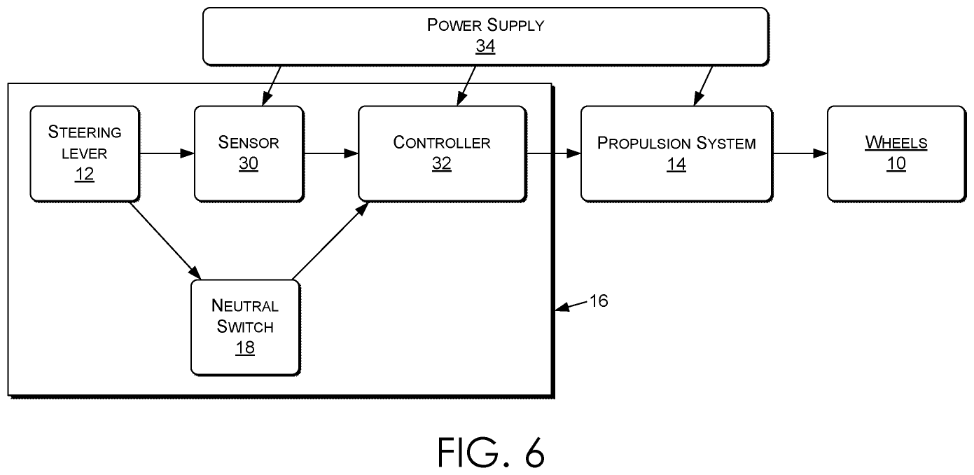

Turning now to the figures generally, and in particular to FIGS. 1-4, the illustrated terrain working vehicle is depicted as a mower 1. The mower 1 is shown as a zero-turn, riding mower having a frame 2, a housing 3 attached to the frame 2 to obscure and/or protect internal componentry, an operator seat 4 coupled to the frame 2, an implement 5 illustrated as a mowing deck coupled to the frame 2 and/or a floor pan 6, drive wheels 10 rotatably coupled to the frame 2, and two steering levers 12 for controlling actuation of the mower 1. In other aspects, the actuation of the mower 1 may be controlled with control inputs other than steering levers (such as the illustrated steering levers. Various operational components of the mower 1 are depicted in FIG. 6 and further described below, including one or more propulsion systems 14 and a drive-by-wire steering control system 16.

For ease of reference when describing the mower 1, and portions thereof, three orthogonal axes are illustrated in FIGS. 1-4. In particular, an X-axis, a Y-axis, and a Z-axis are shown. The X-axis is associated with a longitudinal (e.g., front-to-back) direction of the mower 1. The Y-axis is associated with a lateral (e.g., side-to-side) direction of the mower 1. The Z-axis is associated with a vertical (e.g., bottom-to-top) direction of the mower 1.

The frame 2 of mower 1 may be made of any rigid material for supporting the implement 5, the operator seat 4 and an operator seated therein, and the load associated with the other componentry of the mower 1. For example, the frame 2 may be comprised of tube steel (e.g., rectangular tube steel, square tube steel, round tube steel, etc.) or steel formed into other geometries (e.g., C-channels, frame channel, frame rail, sheets, plates, etc.). In other aspects, the frame may be made from materials other than steel. In some aspects, the frame 2 may comprise a vehicle chassis. The housing 3 may comprise a fender made of any rigid (e.g., steel) or non-rigid (e.g., plastic, polymer, etc.) material for obscuring, restricting access to, and shielding some components of the mower 1, such as some of the operational components of FIG. 6 below. Additionally, or alternatively, the housing 3 or portions thereof may be integrally formed with the frame 2. The operator seat 4 may be sized and shaped for a human operator to sit thereon and may be located between the two steering levers 12. However, the operator seat 4 may be omitted without departing from the technology described herein.

The drive wheels 10 may comprise any traditional mechanical wheels, axles, tires, and the like known in the art. The drive wheels 10 may alternatively comprise any ground-engaging actuation components enabling forward propulsion such as treads or the like. The drive wheels 10 may comprise a pair of front wheels and/or a pair of rear wheels. In some embodiments, each of the front wheels and the rear wheels may be drive wheels driven by the propulsion systems 14 described below. However, in other embodiments, only the front wheels or only the rear wheels are drive wheels driven by the propulsion systems 14. For example, a first independent propulsion system may drive a left one of the rear wheels and a second independent propulsion system may drive a right one of the rear wheels.

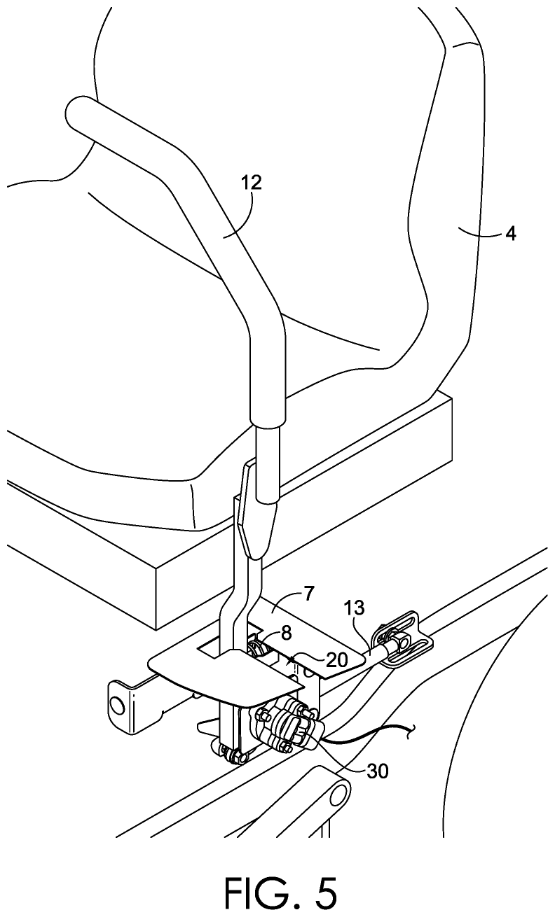

Each of the steering levers 12 of the mower 1 may control one of the propulsion systems 14 via the drive-by-wire steering control system 16 described below. Further, each steering lever 12 of the mower 1 also may actuate a neutral switch 18, as schematically depicted in FIG. 6, and/or other aspects of the mower 1. In some embodiments, as depicted in FIG. 5, each steering lever 12 may be part of a steering control that includes both a lever and a damping mechanism 13 (e.g., a dashpot, spring, etc.) providing physical resistance to the lever as the lever is moved by a human operator, thereby providing tactile feedback to the human operator. In addition to the damping mechanism 13, some embodiments may include one or more springs or other biasing components configured for biasing the steering lever 12 towards neutral when not being acted upon by an operator. For example, FIG. 5 depicts a spring 8 on the rearward side of the steering lever 12 that biases the steering lever 12 towards the neutral position when the steering lever is moved rearward (e.g., to cause rearward propulsion). However, these springs may be omitted without departing from the scope of the technology described herein. For the sake of brevity, only one steering lever 12 will be discussed below, except as explicitly stated otherwise. However, the following discussion applies equally to the other steering lever 12.

In some aspects, the steering lever 12 may be coupled to a two-axis pivot assembly comprised of polymer or other rigid materials. Such a two-axis pivot assembly may include an attachment housing having a boss extending from each side thereof in opposing directions. The steering lever 12 may be coupled to the attachment housing such that it rotates around a first axis of rotation associated with the two bosses. The first axis of rotation may be associated with the steering lever 12 moving in a longitudinal direction of the mower 1. Further, the steering lever 12 may be pivotally coupled to the attachment housing such that the steering lever 12 may rotate relative to the attachment housing. For example, the attachment housing may include an opening through which the steering lever 12 may be inserted and a pin may extend through the attachment housing and the steering lever 12. The opening may be sized to allow the steering lever 12 to rotate within the opening. Thus, in aspects, the steering lever may rotate around a second axis of rotation associated with the pin. The second axis of rotation may be associated with the steering lever moving in a lateral direction of the mower 1.

Turning now to FIGS. 1-5, a “T” shaped slot opening 20 may be formed through a panel 7 coupled to the frame 2. The housing 3 may surround the panel 7. In some aspects, the housing 3 includes an aperture through which the panel 7 is received. The steering lever 12 may extend through the “T” shaped slot opening 20. In some aspects, the “T” shaped slot opening 20 may be shaped to present a longitudinal portion 22 having a first end 24 and a second end 26 opposite the first end 24. In some aspects, the first end 24 and the second end 26 may provide a physical obstruction to limit movement of the steering lever 12 in the longitudinal direction. In further aspects, the T″ shaped slot opening 20 may also be shaped to present a lateral portion 28 extending in a lateral direction and/or substantially perpendicular to the longitudinal portion 22. The lateral portion 28 allows the steering lever 12 to move in the lateral direction of the mower 1.

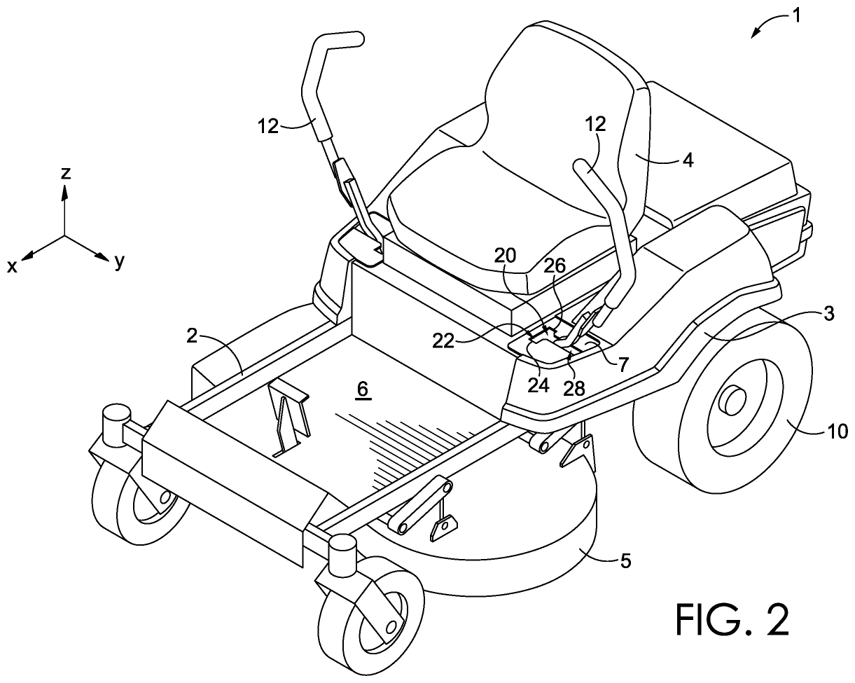

In some aspects, the lateral portion 28 may begin at a point substantially midway between the first end 24 and the second end 26 of the longitudinal portion 22 and extend outward therefrom. In other aspects, the lateral portion 28 may be positioned nearer one of the first end 24 and the second end 26. The lateral portion 28 provides a mechanical neutral position of the steering lever 12, as depicted in FIG. 2. In other words, the lateral portion 28 restricts or limits the longitudinal movement of the steering lever 12 by presenting a physical obstruction to such movement. The mechanical neutral position, as used herein, corresponds to a position of the steering lever 12 at which the controller instructs the propulsion system to drive neither forwards nor backwards but rather remain idle.

Although the above description focused on a two-axis pivot assembly where a steering lever pivots within a “T” shaped slot, other types of steering levers may be used and different shaped slots may be used without departing from the scope of the technology described herein. For example, some steering levers may only pivot along one axis (e.g., longitudinal direction) and may have other features that indicate a mechanical neutral position. Some of these other features could include markings on the housing 3, other protrusions or indentations extending into or outward from the panel 7, the frame 2, and/or other portions of the mower 1 may be used to designate the mechanical neutral position. Further, a neutral switch, as described herein, may be located along the axis of rotation of the steering lever at the designated mechanical neutral position such that the steering lever closes the neutral switch when at the mechanical neutral position. In alternative aspects, the neutral switch may be incorporated into other portions of the mower 1 (e.g., the steering levers may include a break-open feature such that a top portion pivots relative to a lower portion, where such pivoting opens or closes a neutral switch coupled thereto).

Turning now to FIG. 6, the propulsion system 14 may be controlled and operated via a drive-by-wire steering control system 16, which may comprise the steering levers 12 (also referred to herein as “steering controls”), a sensor 30, and a controller 32 for instructing actuation of the propulsion system 14. Furthermore, in some aspects, each steering lever 12 of the mower 1 may actuate one or more neutral switches 18. The opening and/or closure of the neutral switch 18 may be detected by the controller 32, thereby indicating to the controller 32 that a reading or output from the sensor 30 should then be obtained and used to calculate a first electrical signal range or neutral electrical signal band, as described herein. For example, a neutral switch 18 may be positioned such that it is closed when the steering lever 12 is moved fully outward in the lateral portion 28 of the “T” shaped slot 20. The controller 32 may be configured to monitor this neutral switch 18. The opening and/or closure of the neutral switch 18 may be detected by the controller 32 and/or sensor 30 to cause the controller to obtain an electrical signal reading from the sensor 30 and/or command the sensor 30 to output a signal associated with a reading thereof to the controller 32.

The propulsion systems 14 may actuate the drive wheels 10. For example, each propulsion system 14 may comprise as a motor, such as an electric motor, a hydrostatic motor, a hydraulic motor, and/or such other drive mechanisms for rotatably actuating one or more of the drive wheels 10. In some aspects, the propulsion systems 14 further include or are electrically coupled to at least one of a first drive circuit configured to control propulsion of a first drive wheel and a second drive circuit configured to control propulsion of a second drive wheel. Each of the first and second drive circuits may be controlled via one of the two steering levers 12 described herein. In these aspects, the first and second drive circuits may be controlled independently by two independent controllers (as opposed to the single controller) or may be controlled with a single controller (e.g., controller 32). In some aspects, the propulsion system 14 comprises a first electric motor operatively coupled to the first drive wheel and a second electric motor operatively coupled to the second drive wheel.

Control of the propulsion system 14 may be provided via the controller 32 and/or an actuator to turn or otherwise adjust settings of the propulsion system 14. For example, the actuator may control both a speed of the output and a direction of the output (e.g., forward or backward) that the propulsion system 14 provides to one or both of the drive wheels 10. The speed of the output that the propulsion system 14 provides to the drive wheels 10 may be relative to a position of the steering lever 12 within the longitudinal portion 22 of the “T” shaped slot 20.

The sensor 30 may be a Hall Effect sensor (also referred to herein as a Hall sensor) or any sensor configured to output an electric signal corresponding to a physical location of the steering lever 12. A Hall Effect sensor is defined herein as a device used to measure a magnitude of a magnetic field and to output voltage directly proportional to the magnetic field strength through the Hall Effect sensor. In one example embodiment, a range of zero to six volts may be output from the sensor 30 to the controller 32, or more specifically a range of 0.5 volts to 4.5 volts. Furthermore, in some embodiments, the Hall Effect sensor may output a voltage based on a proximity of magnets placed onto or within particular points on the steering lever 12. Conversely, in some embodiments, the Hall Effect sensor may be located on the steering lever 12 and may respond with particular voltage outputs to the controller 32 based on its proximity to certain magnets at given points along the slot 20, its longitudinal portion 22, the first and/or second ends 24, 26, and/or along a portion of the lateral portion 28. Such magnets may be placed on the frame 2, the housing 3, or other structures of the mower 1. In some aspects, the Hall Effect sensor is directly coupled to the controller 32 such that the controller 32 receives a voltage output from said sensor. In other aspects, the Hall Effect sensor and/or electrical components convert the voltage output into any other form of electrical signal prior to the controller 32 receiving said electrical signal. In some aspects, other types of sensors 30 may be used other than a Hall Effect sensor. For example, a rheostat switch, a potentiometer, an optical sensor, or some other type of sensor may be used instead of a Hall Effect sensor. In further aspects, multiple sensors could be used for each steering control. Utilizing multiple sensors may be beneficial when a nonlinear response is intended between the movement of the steering control and the output of the associated propulsion system.

The controller 32 may be physically, electrically, and/or communicably coupled with the propulsion system 14. In some embodiments, as described above, a separate controller 32 may be used for each of two propulsion systems associated with each of two sensors providing signals associated with each of two steering levers 12. In other embodiments, a single controller 32 may be used with one or more sensors 30. The controller 32 may be configured and communicably coupled to receive input from the sensor 30, such as voltage therefrom, and may use this input for at least one of calibrating a neutral signal band and/or driving the mower 1. Furthermore, the controller 32 may be communicably coupled with the neutral switches 18 for determining when the steering levers 12 are in the mechanical neutral position. The controller 32 may accordingly output signals to the propulsion system 14 indicating both direction and speed for turning one or more of the drive wheels 10. The controller 32 may comprise various drive circuits, computer processing technology, and data storage technology, such as the computer-readable media and computer storage media described herein.

Utilizing a neutral switch 18 to inform the controller 32 about the mechanical position of the steering lever 12 can result in problems if the mechanical neutral position at which the neutral switch is located becomes misaligned with the sensor 30 neutral signal, as encountered in prior art systems. As discussed herein, the misalignment may result from a physical misalignment between the steering control and the signal band recognized by the controller as corresponding to the neural position, a sensor misalignment, sensor wear, operating conditions (e.g., temperature and/or pressure), among other factors. In some aspects, this misalignment can cause the sensor 30 to send a signal to the controller 32 indicating that propulsion in a forward or rearward direction should be instructed while at the same time the steering lever 12 may be in the mechanical neutral position and actuating the neutral switch 18 being monitored by the controller 32. When this misalignment occurs, the logic on the controller 32 causes the controller 32 and/or other systems on the mower 1 to fault out (and in some cases disable the mower, or portions of the mower, until a service technician comes to the disabled mower and/or the disabled mower is brought in for service). The misalignment may be small and difficult to detect and/or diagnose and could cause customer dissatisfaction and unnecessary warranty expense. This misalignment problem can be completely avoided utilizing the technology described herein (e.g., every-use calibration, regular calibration, interval calibration, etc.).

In some aspects, during a calibration operation, the controller 32 may be configured to receive a first electrical signal from the sensor 30 when the steering lever 12 is in the mechanical neutral position. In some aspects, the first electrical signal may be of a particular voltage or amperage detected by the controller 32. The calibration operation may be triggered by closing or opening of the neutral switch 18 or any other trigger. Specifically, the controller 32 may be configured to determine the neutral switch 18 is closed prior to detecting a starting position of the steering lever 12 with the sensor 30, since the closed neutral switch 18 may indicate that the steering lever 12 is in the mechanical neutral position. Then, when the steering lever is moved and the neutral switch 18 opens, the controller 32 may accept a first electrical signal from the sensor 30. Based on the first electrical signal, the controller 32 may be configured to determine a first electrical signal range or neutral electrical signal band that is associated with the steering lever 12 being aligned with the mechanical neutral position. The neutral electrical signal band may have a first boundary and a second boundary and may be generally centered about the first electrical signal. For example, the neutral electric signal band or range may be approximately plus and/or minus 0.1 volts from a voltage of a first electrical signal output by the sensor 30 when the steering lever 12 is aligned with the mechanical neutral position. In other aspects, the neutral electrical signal band may not be centered about the first electrical signal. For example, the neutral electric signal band or range may be approximately 0.1 volts above to 0.05 volts below a voltage of a first electrical signal output by the sensor 30 when the steering lever 12 is aligned with the mechanical neutral position. In still other aspects, the neutral electrical signal band may comprise only a single voltage and not have a range. For example, the neutral electrical signal band may be plus and/or minus 0.0 volts from a voltage of a first electrical signal output by the sensor 30 when the steering lever 12 is aligned with the mechanical neutral position.

The neutral electrical signal band thus may correspond to a neutral state of the steering lever 12 and may be associated with a neutral band of intermediate steering control positions between the first position at the first end 24 and the second position at the second end 26 of the “T” shaped slot 20. Moreover, having a signal band allows for the neutral band of intermediate steering control positions to overlap a forward edge and a rearward edge of the lateral portion 28 of the “T” shaped slot 20. In another aspect, as discussed above, the neutral electrical signal band may comprise only a single value and not have a range. In this aspect, the neutral band of intermediate steering control positions comprise a single steering control position.

This calibration operation thereby calibrates the controller 32 to whatever first electrical signal is output by the sensor 30, rather than using a preset voltage value or a preset neutral electrical signal band. In some aspects, the above described calibration operation is performed every time the state of the neutral switch changes from open to closed and/or closed to open. In other aspects, the calibration operation may not be performed when the neutral switch changes from open to closed and/or closed to open. For example, the above described calibration operation may be performed every time the terrain working vehicle is energized (e.g., the key is turned from an off to an on position, the vehicle is energized with a power on switch, the vehicle is otherwise powered on, and the like). Thus, movement of the steering lever 12 in the lateral portion of the “T” shaped slot 20 is not required in accordance with these aspects. In all of these aspects, however, the calibration operation avoids the misalignment problems described above altogether.

Following the calibration operation, the controller 32 may be configured to output direction and/or speed instructions or commands to the propulsion system 14 based on pre-programmed algorithms corresponding to a difference between a received present electrical signal from the sensor 30 and the neutral electrical signal band calculated during the calibration operation. For example, motor control firmware on the controller 32 may be programmed with a range of zero to six volts from the sensor 30 to drive a motor/gearbox axle shaft from 150 rpm counter-clockwise to 150 rpm clockwise. The instructions to the propulsion system 14 may be output to control the amperage of an electric motor or the like.

In some aspects, the controller 32 may be configured to instruct the propulsion system 14 to cause movement of the mower 1 in a first direction when the steering lever 12 is at the first position (i.e. at the first end 24 of the slot 20) or between the first position and the neutral band of intermediate positions. For example, the first position or any position between the first position and the neutral band of intermediate positions may cause the sensor 30 to output a voltage above the neutral electrical signal band. Receiving a voltage above or outside of the first boundary of the neutral electrical signal band may cause the controller 32 to instruct the propulsion system 14 to move in the first direction. Likewise, the controller may be configured to instruct the propulsion system 14 to cause movement of the mower 1 in a second direction when the steering lever 12 is at the second position (i.e., at the second end 28 of the “T” shaped slot 20) or between the second position and the neutral band of intermediate positions. For example, the second position or any position between the second position and the neutral band of intermediate positions may cause the sensor 30 to output a voltage below the neutral electrical signal band. Receiving a voltage below or outside of the second boundary of the neutral electrical signal band may cause the controller 32 to instruct the propulsion system 14 to move in the second direction. Meanwhile, the controller 32 may be configured to instruct the propulsion system 14 to cease causing movement of the mower 1 when the steering lever 12 is in the neutral band of intermediate positions. With the steering lever 12 within the neutral band of intermediate positions, the sensor 30 outputs a voltage within the neutral electrical signal band, where the mower 1 is to remain in a neutral state. Note that a neutral state does not necessarily mean a state in which the mower 1 is restricted from moving, but rather references a state at which the mower is not being actively driven forward or rearward by the propulsion system 14. For example, if the mower 1 is on sloped terrain in the neutral state, it may travel downhill unless a brake is applied or an obstacle is placed in front of one of the drive wheels 10. In some alternative aspects, however, the propulsion system may also be configured to act as a brake.

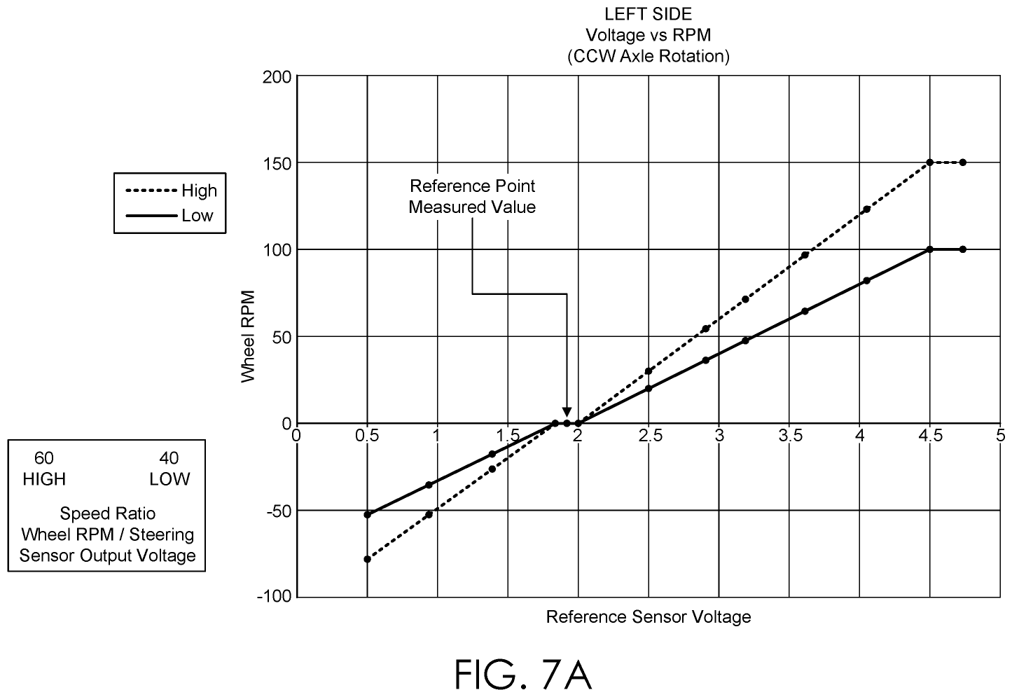

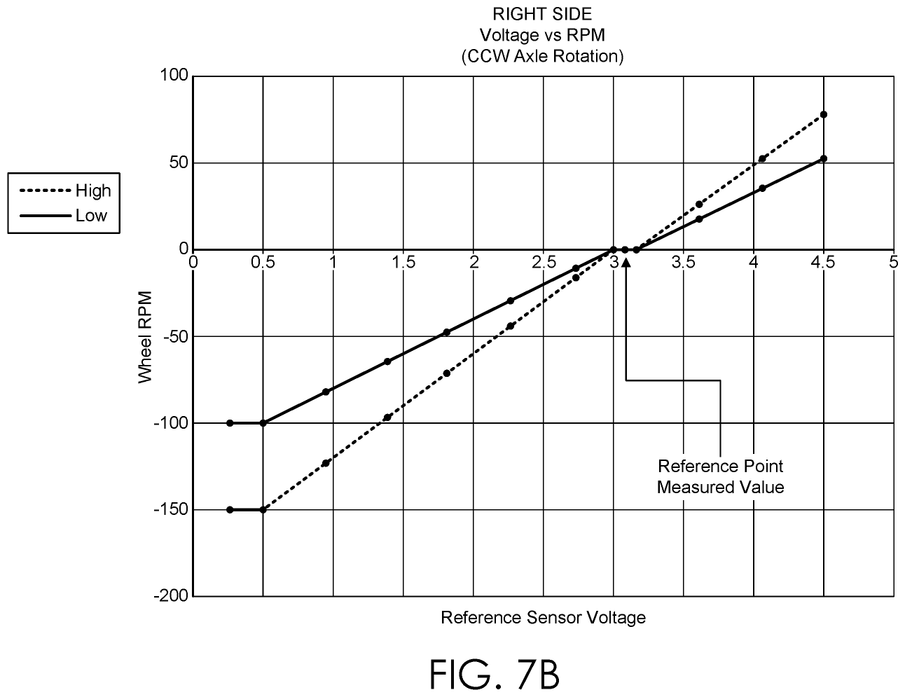

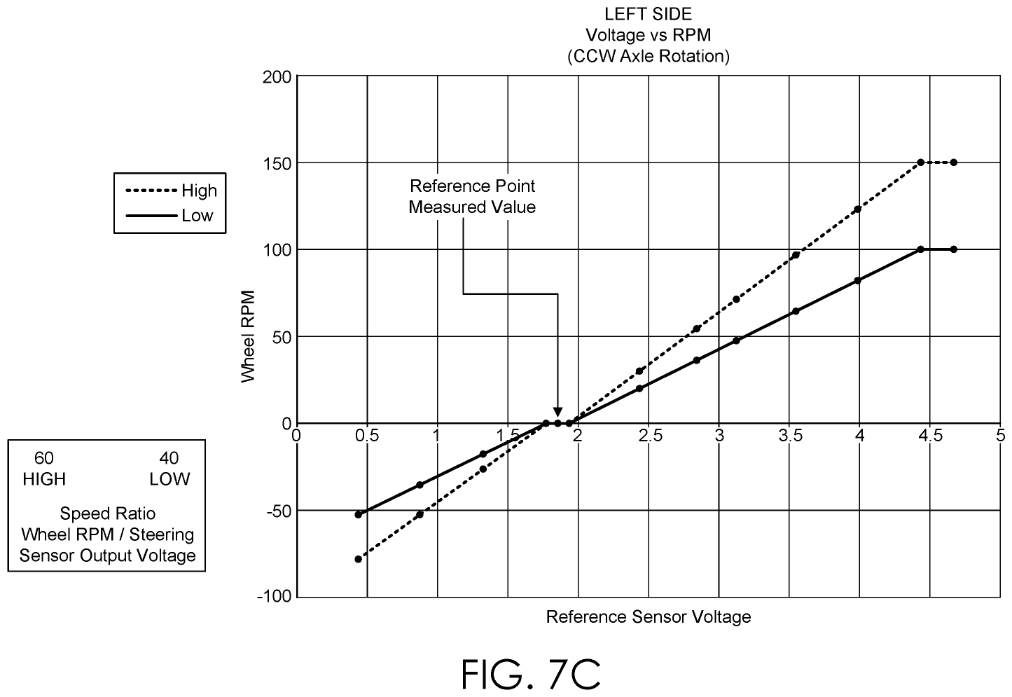

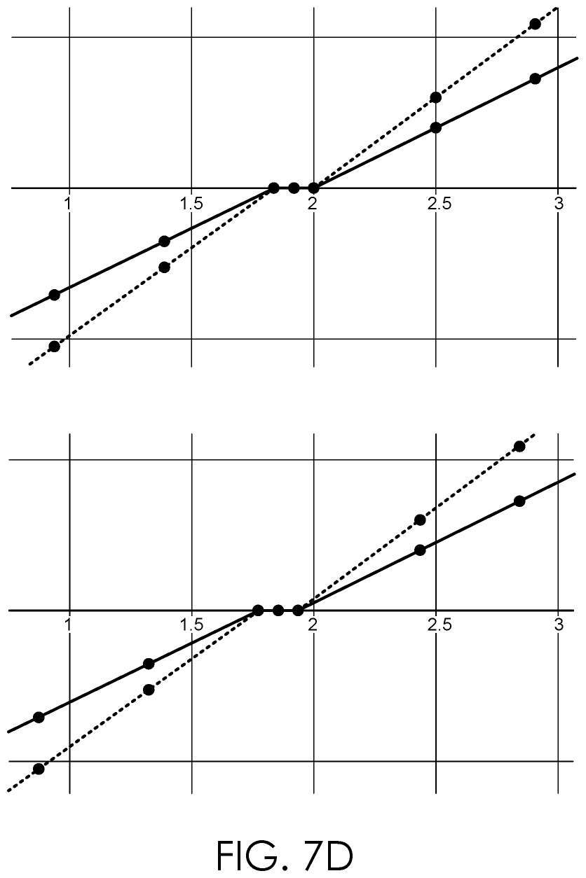

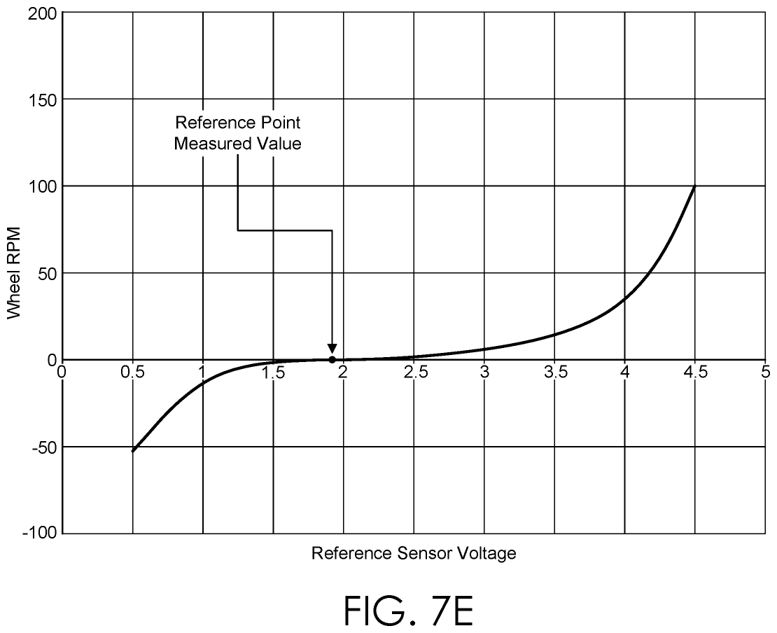

As noted above, in some embodiments, first and second drive circuits of the propulsion system 14 may be controlled independently by two independent controllers. Further efficiencies are realized during manufacture and/or service of the terrain working vehicle when the two independent controllers are identical parts. In an exemplary embodiment, a first controller is configured to control a first drive circuit associated with the left drive wheel and a second controller is configured to control a second drive circuit associated with the right drive wheel. This embodiment is graphically illustrated in FIGS. 7A and 7B, which demonstrate a plot of sensor voltage versus wheel revolutions per minute (“RPM”). Note that FIGS. 7A and 7B depict wheel rotations per minute relative to the sensor 30 output voltage, as commanded by controller 32. However, these are merely examples and may vary depending on a number of factors (e.g., type of propulsion system, terrain encountered by the vehicle, etc.). These figures are plotting the wheel RPM as viewed from the left side of the terrain working vehicle, where counterclockwise rotation of the wheel axle results in forward propulsion of the associated drive wheel and clockwise rotation of the wheel axle results in rearward propulsion of the associated drive wheel.

As seen in FIG. 7A, the above described calibration operation has been carried out, where a first electrical signal of about 1.9 volts was sent to the first controller. The first controller then set a neutral electrical signal band of approximately 1.8 volts to 2.0 volts. Forward propulsion is commanded by the first controller for the left drive wheel when a voltage received by the first controller is greater than about 2.0 volts. In this aspect, when a left side steering lever 12 is at the first position (e.g., an end of the “T” shaped slot) the voltage measured by the sensor is about 4.5 volts. Rearward propulsion is commanded by the first controller for the left drive wheel when a voltage received by the first controller is less than about 1.8 volts. In this aspect, when the left side steering lever 12 is at the second position (e.g., an opposite end of the “T” shaped slot from the first position) the voltage measured by the sensor is about 0.5 volts.

A similar plot is depicted in FIG. 7B for the second drive circuit. Again, the above described calibration operation has been carried out, where a first electrical signal of about 3.1 volts was sent to the second controller. The second controller then set a neutral electrical signal band of approximately 3.0 volts to 3.2 volts. Forward propulsion is commanded by the second controller for the right drive wheel when a voltage received by the second controller is less than about 3.0 volts. In this aspect, when a right side steering lever 12 is at the first position (e.g., an end of the “T” shaped slot) the voltage measured by the sensor is about 0.5 volts. Rearward propulsion is commanded by the second controller for the right drive wheel when a voltage received by the second controller is greater than about 3.2 volts. In this aspect, when the steering lever 12 is at the second position (e.g., an opposite end of the “T” shaped slot from the first position) the voltage measured by the sensor is about 4.5 volts.

The motor control firmware on both the first controller and the second controller, in the above embodiment, views the axle of both drive wheels from the left side of the terrain working vehicle which dictates a clockwise and counterclockwise direction. Hence, in the above embodiment, the same part (i.e., the controller 32) may be installed on the terrain working vehicle twice, once as the first controller and again as the second controller (i.e., two independent controllers, but matching part numbers). This embodiment reduces manufacturing and servicing expense of the terrain working vehicle described herein as only a single part must be kept in inventory instead of two distinct parts. In an alternative embodiment, however, unique controllers may be used such that the first controller is identical to that described above but the second controller is not identical to that described above. Instead, the motor control firmware views the axle of the right drive wheel from the right side of the terrain working vehicle, which results in forward propulsion being associated with clockwise rotation and rearward propulsion being associated with counterclockwise rotation, in accordance with this alternative embodiment. This alternative embodiment may then also set up the terrain working vehicle such that the first electrical signal of both the right side and the left side are approximately the same value. For example, the first electrical signal for both sides could be about 1.9 volts. In this example, the plot of sensor voltage versus wheel RPM for the second drive circuit (i.e., right side) would be identical to that shown in FIG. 7A, except that it would be for clockwise rotation instead of counterclockwise rotation.

In still other embodiments, a single controller 32 may be used to control a right side propulsion system and a left side propulsion system. In these aspects, a right side sensor may provide a first voltage output to the controller and the left side sensor may provide a second voltage output to the controller. In this example, one way for the controller 32 to differentiate the first voltage output from the second voltage output is by the magnitude of the voltage output. In other words, the controller 32 may associate all voltages with in a first range of voltages with the right side sensor and may further associate all voltages within a second range of voltages with the left side sensor. Thus, in accordance with this example, any voltage received from either side sensor in the first range of voltages may result in instructions being sent to the right side propulsion system. Likewise, in accordance with this example, any voltage received from either side sensor in the second range of voltages may result in instructions being sent to the left side propulsion system.

Over time, the first electrical signal detected by the sensor 30 when the steering lever 12 is in the mechanical neutral position may change due to misalignment, as discussed above. For example, the conditions and configurations of the steering lever 12, the sensor 30, or other portions of the mower 1 may change over time and result in a first electrical signal that is different than that which would be detected when the mower 1 was first assembled.

For example, the mower 1 may be assembled such that the first electrical signal output by the sensor 30 may be about 1.9 volts and have a voltage versus RPM plot as depicted in FIG. 7A. One year later, the first electrical signal output by the sensor 30 may be about 1.8 volts and have a voltage versus RPM plot as depicted in FIG. 7C. The difference in the first electrical signal output (i.e., the reference point) results in the neutral band shifting from about 1.8-2.0 volts to about 1.7-1.9 volts. A portion of FIGS. 7A and 7C have been reproduced in FIG.7D to illustrate this change in the neutral band over time.

Speed instructions or commands provided by the controller 32 to the propulsion system 14 may be calculated such that speed of the drive wheel 10 varies linearly relative to a difference between a present electrical signal from the sensor 30 and the neutral electrical signal band or range. For example, the speed instructions may be based on a predetermined value for a ratio of the steering speed sensor output voltage and a change in drive motor speed. This may be represented by a slope of a sample curve provided in FIGS. 7A and 7B for both high and low speed ranges. However, the speed instructions output by the controller 32 to the propulsion system 14 may be calculated as a linear relationship, a non-linear relationship, a logarithmic relationship, or any mathematical relationship without departing from the scope of the technology described herein. For example, as plotted in FIG. 7E, a first five degrees of travel or pivoting of the steering lever 12 away from the mechanical neutral position may increase the wheel 10 speed less than a last five degrees of travel or pivoting before reaching the first end 24 or the second end 26 of the slot 20. This may be helpful, particularly for zero-turn vehicles, where the propulsion system 14 is controlling both speed and steering direction. When maneuvering around obstacles (e.g., flower beds), more precise maneuvering may require more lever movement to increase acceleration, thus avoiding accelerating too quickly with slight movements. Likewise, less precise maneuvering (e.g., long straight lines) may require less lever movement to increase acceleration, where rapid acceleration is desirable.

The power supply 34 may comprise a battery, generator, alternator driven by a combustion engine, and/or any other power source known in the art. The power supply may provide operational power to one or more of the following: the propulsion system 14, the sensor 30, the controller 32, the neutral switch 18, and/or any other sensors, circuitry, switches, pumps, actuators, or motors of the mower 1.

In some aspects, if mechanical or sensor misalignment is too great, the mower 1 can still operate from any reference point (e.g., the voltage of the first electrical signal from the sensor 30 when the steering lever 12 is in the mechanical neutral position). However, if the reference point is too close to a minimum or maximum output of the sensor 30, the corresponding wheel 10 may not reach its maximum speed in one direction, causing the corresponding wheel 10 to run too slow. To avoid extremes of this phenomenon, in some embodiments, absolute minimum and absolute maximum reference points of first electrical signals from sensor 30 may be set via the controller 32. For example, in one embodiment any time the first electrical signal from the sensor 30 is more than plus or minus 0.5 volts from expected reference point values, the controller 32 may cause the mower 1 to fault out, requiring manual calibration adjustments. Alternatively, some aspects may include ways for the controller 32 to determine if the steering lever 12 is in the mechanical neutral position (e.g., the neutral switch, other sensors, etc.) and if the first electrical signal from the sensor 30 is more than plus or minus 0.5 volts from expected reference point values the controller can indicate a mechanical fault or a non-mechanical fault.

Furthermore, the propulsion system 14 and/or the controller 32 may be configured to prevent wheel speed from continuing to increase beyond upper and lower voltage limits. Referring to FIG. 7A as an example, the controller 32 may be configured to only increase wheel speed in the forward direction for the first 2.5 volts above the neutral band (e.g., 2.0-4.5 volts). Should a shift in expected first electrical signal occur that would permit the sensor 30 to measure a voltage greater than 2.5 volts above the neutral band, the controller 32 may be configured to only command forward propulsion at a specified maximum speed (e.g., 150 RPM). The controller 32 may be similarly configured to only increase wheel speed in the rearward direction for the first 1.3 volts below the neutral band (e.g., 0.5-1.8 volts).

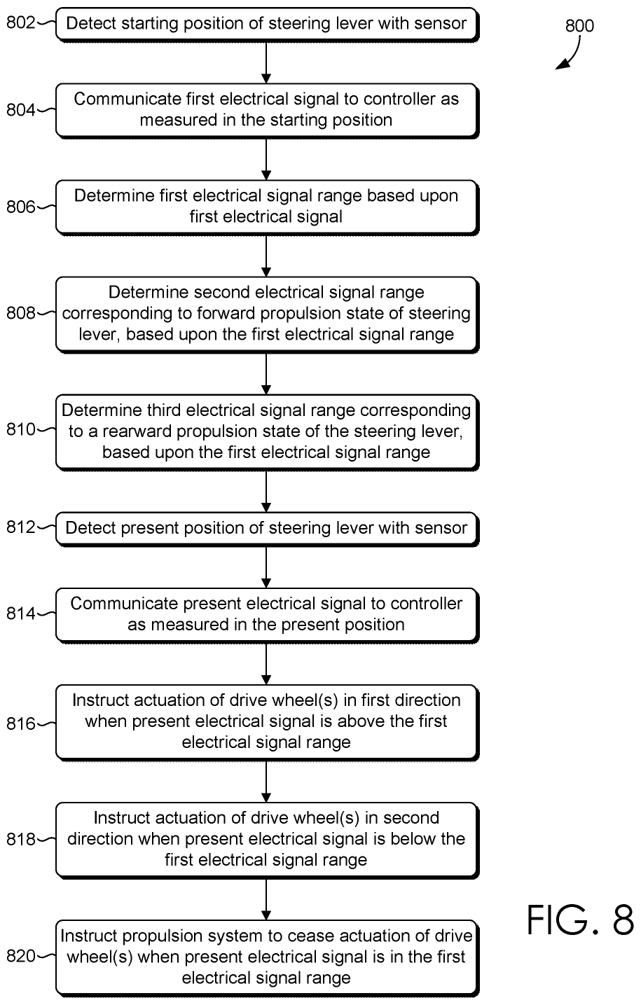

As depicted in FIG. 8, the drive-by-wire steering control system 16 described above may be used in a method 800 for setting an electrical signal range corresponding to a mechanical neutral position of the steering lever 12 of a terrain working vehicle (such as the mower 1). At least a portion of the steps of the method 800 in accordance with various embodiments of the present invention are listed in FIG. 8. The steps may be performed in the order as shown in FIG. 8, or they may be performed in a different order. Further, some steps may be performed concurrently as opposed to sequentially. In addition, some steps may be omitted. Still further, embodiments of the present invention may be performed using systems other than the systems and apparatuses described herein without departing from the scope of the technology described herein.

The method 800, as depicted in block 802, may include detecting a starting position of a steering lever (e.g., steering lever 12) with a sensor (e.g., sensor 30). The starting position corresponds to the steering lever being aligned with the mechanical neutral position and the sensor may be capable to output an electrical signal based upon measuring a position of the steering lever, as described above. In some aspects, this detecting step may be triggered by the controller (e.g., controller 32) determining that a neutral switch (e.g., neutral switch 18) is open or closed, which may indicate that the steering lever is aligned with the mechanical neutral position.

The method 800, as depicted in block 804, may also include communicating a first electrical signal to the controller as measured in the starting position. Then, as depicted in block 806, the method 800 may include determining a first electrical signal range or neutral electrical signal band based upon the first electrical signal. The first electrical signal may have a voltage or amperage about which the first electrical signal range or neutral electrical signal band is centered. Furthermore, the first electrical signal range may correspond to a neutral state of the terrain working vehicle and/or the steering lever being positioned with a neutral band of intermediate positions.

In some embodiments, the method 800 may also comprise determining a second electrical signal range corresponding to a forward propulsion state of the terrain working vehicle, as depicted in block 808, and determining a third electrical signal range corresponding to a rearward propulsion state of the terrain working vehicle, as depicted in block 810. These second and third electrical signal ranges may be based upon the first electrical signal range. For example, the second electrical signal range may have a minimum voltage corresponding to a maximum voltage of the first electrical signal range, while the third electrical signal range may have a maximum voltage corresponding to a minimum voltage of the first electrical signal range. In some embodiments, the second electrical signal range includes any electrical signal above the first electrical signal range, while the third electrical signal range includes any electrical signal below first electrical signal range. However, the steps of determining the second and third electrical signal ranges may be omitted without departing from the scope of the technology described herein.

In some embodiments, the method 800 may further comprise, as depicted in block 812, detecting a present position of the steering lever 12 with the sensor 30. This present position may be any position to which the operator actuates the steering lever 12 following calibration (i.e., determination of the neutral electrical signal band). The method 800, as depicted in block 814, may then include communicating a present electrical signal to the controller 32 as measured in the present position. This may be accomplished via the sensor 30 based on the present position of the steering lever 12.

The method 800, as depicted in block 816, may further include instructing actuation of the drive wheel(s) (e.g., drive wheels 10) of the terrain working vehicle in a first direction when the present electrical signal is above the first electrical signal range. Likewise, the method 800, as depicted in block 818, may include instructing actuation of the drive wheel(s) in a second direction opposite the first direction when the present electrical signal is below the first electrical signal range. For example, this instructing step may include commanding an electric actuator to adjust a setting of a drive motor or propulsion system (e.g., propulsion system 14) associated with and/or coupled to the drive wheel(s). As described above, a speed of the drive wheel(s) may vary linearly relative to a difference between the present electrical signal and the first electrical signal range. The method 800, as depicted in block 820, may also include instructing the propulsion system to cease actuation of the drive wheels(s) when the present electrical signal is in the first electrical signal range. However, in some embodiments, block 820 may be omitted without departing from the scope of the technology herein. For example, if the present electrical signal is in the first electrical signal range, the controller may just cease sending output to the propulsion system, which may indicate to the propulsion system to cease actuating the wheel(s).

Some of the subject matter disclosed herein may be provided as, at least in part, a method, a system, and/or a computer-program product, among other things. Accordingly, certain aspects disclosed herein may take the form of hardware, or may be a combination of software and hardware. A computer-program that includes computer-useable instructions embodied on one or more computer-readable media may also be used. The subject matter hereof may further be implemented as hard-coded into the mechanical design of computing components and/or may be built into a system or apparatus that enables calibration and propulsion of the terrain working vehicle as described herein.

Computer-readable media may include volatile media, non-volatile media, removable media, and non-removable media, and may also include media readable by a database, a switch, and/or various other network devices. Network switches, routers, and related components are conventional in nature, as are methods of communicating with the same, and thus, further elaboration is not provided in this disclosure. By way of example, and not limitation, computer-readable media may comprise computer storage media and/or non-transitory communications media.

Computer storage media, or machine-readable media, may include media implemented in any method or technology for storing information. Examples of stored information include computer-useable instructions, data structures, program modules, and/or other data representations. Computer storage media may include, but is not limited to, RAM, ROM, EEPROM, flash memory or other memory technology, CD-ROM, digital versatile discs (DVD), holographic media or other optical disc storage, magnetic cassettes, magnetic tape, magnetic disk storage, and other storage devices. These memory components may store data momentarily, temporarily, and/or permanently, and are not limited to the examples provided herein.

Additionally, although some exemplary implementations of the embodiments described herein are shown in the accompanying figures, these implementations are not intended to be limiting. Rather, it should be understood that the various embodiments and aspects described herein may be implemented upon any terrain working vehicle having a drive-by-wire steering control system.

Many different arrangements of the various components depicted, as well as components not shown, are possible without departing from the spirit and scope of the present invention. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention.

What is claimed:

1. A method for setting an electrical signal range corresponding to a mechanical neutral position of a drive-by-wire control of a terrain working vehicle, the method comprising:
detecting a starting position of the drive-by-wire control with a sensor, wherein the starting position is a mechanical neutral position for the drive-by-wire control, the sensor capable to output an electrical signal based upon measuring a control position;
communicating a first electrical signal to a controller as measured in the starting position; and
based upon the first electrical signal, determining a first electrical signal range corresponding to a neutral state of the drive-by-wire control.

2. The method of claim 1 further comprising determining a neutral switch of the terrain working vehicle is closed prior to detecting the starting position of the drive-by-wire control with the sensor.

3. The method of claim 1, wherein the first electrical signal has a voltage or amperage about which the first electrical signal range is centered.

4. The method of claim 1, further comprising:
detecting a present position of the drive-by-wire control with the sensor;
communicating a present electrical signal to the controller as measured in the present position; and
instructing actuation of a drive wheel of the terrain working vehicle in a first direction when the present electrical signal is outside of a first boundary of the first electrical signal range.

5. The method of claim 4, further comprising instructing actuation of the drive wheel of the terrain working vehicle in a second direction opposite the first direction when the present electrical signal is outside of a second boundary of the first electrical signal range.

6. The method of claim 4, wherein instructing actuation of the drive wheel includes adjusting a power supplied to a drive motor of the drive wheel.

7. The method of claim 4, wherein speed of the drive wheel varies linearly relative to a difference between the present electrical signal and the first electrical signal range.

8. The method of claim 1, wherein the first electrical signal range comprises the first electrical signal +/−0.1 volts.

9. A drive-by-wire control system for a terrain working vehicle, the system comprising:
a controller;
a propulsion control configured to move between a first position and a second position, wherein the propulsion control has a mechanical neutral position intermediate to the first position and the second position;
a sensor configured to communicate an electrical signal to the controller, the electrical signal based upon a position of the propulsion control, wherein the sensor communicates a first electrical signal to the controller when the terrain working vehicle is turned on and the propulsion control is in the mechanical neutral position;
the controller configured to determine a neutral electrical signal band based upon the first electrical signal received from the sensor, wherein the neutral electrical signal band is associated with a neutral band of intermediate propulsion control positions between the first position and the second position; and
the controller configured to communicate with a propulsion system of the terrain working vehicle,
(1) wherein the controller instructs the propulsion system to cause movement of a drive wheel of the terrain working vehicle in a first direction when the propulsion control is at the first position or between the first position and the neutral band of intermediate propulsion control positions,
(2) wherein the controller instructs the propulsion system to cease causing movement of the drive wheel of the terrain working vehicle when the propulsion control is in the neutral band of intermediate propulsion control positions, and
(3) wherein the controller instructs the propulsion system to cause movement of the drive wheel of the terrain working vehicle in a second direction when the propulsion control is at the second position or between the second position and the neutral band of intermediate propulsion control positions.

10. The drive-by-wire control system of claim 9, wherein the propulsion control comprises a steering lever pivotable in a longitudinal direction of the terrain working vehicle.

11. The drive-by-wire control system of claim 10, wherein the steering lever is pivotable in a lateral direction of the terrain working vehicle when positioned in the neutral band of intermediate propulsion control positions.

12. The drive-by-wire control system of claim 10, wherein the controller, the sensor, and the steering lever comprise a first drive circuit of the propulsion system of the terrain working vehicle configured to control propulsion of a first drive wheel, the propulsion system further comprising a second drive circuit having a second controller, a second sensor, and a second steering lever configured to control propulsion of a second drive wheel.

13. The drive-by-wire control system of claim 12, wherein the propulsion system further comprises a first electric motor operatively coupled to the first drive wheel and a second electric motor operatively coupled to the second drive wheel.

14. The drive-by-wire control system of claim 10, wherein the propulsion control includes a damping mechanism providing physical resistance to the steering lever as the steering lever is moved away from the mechanical neutral position.

15. The drive-by-wire control system of claim 9, wherein the sensor is a Hall effect sensor.

16. A method for setting an electrical signal range corresponding to a mechanical neutral position of a drive-by-wire control of a terrain working vehicle, the method comprising:
receiving a first electrical signal from a sensor when a propulsion control is in a mechanical neutral position;
based upon the first electrical signal, determining a first electrical signal range corresponding to a neutral state of the propulsion control;
based upon the first electrical signal range, determining a second electrical signal range corresponding to a forward propulsion state of the propulsion control and a third electrical signal range corresponding to a rearward propulsion state of the propulsion control;
receiving a present electrical signal from the sensor; and
instructing a propulsion system of the terrain working vehicle to:
(1) initiate forward propulsion when the present electrical signal is in the second electrical signal range;
(2) initiate rearward propulsion when the present electrical signal is in the third electrical signal range; and
(3) cease propulsion when the present electrical signal is in the first electrical signal range.

17. The method of claim 16, wherein the second electrical signal range includes any electrical signal greater than the first electrical signal range.

18. The method of claim 16, wherein the third electrical signal range includes any electrical signal less than the first electrical signal range.

19. The method of claim 16, further comprising determining a neutral switch is closed by the propulsion control being in the mechanical neutral position.

20. The method of claim 16, wherein initiating forward propulsion comprises calculating a speed of forward propulsion and outputting an instruction to the propulsion system corresponding to the speed of forward propulsion, wherein the speed of forward propulsion is proportional to a difference between the first electrical signal range and the present electrical signal when the present electrical signal is in the second electrical signal range.

21. The method of claim 20, wherein the instruction to the propulsion system corresponding to the speed of forward propulsion is an instruction to control an amperage of an electric motor.
